(19) United States
(12) Patent Application Publication
(10) Pub. No.: US 2015/0036256 A1
(43) Pub. Date: Feb. 5, 2015

(54) Method for Design of Subsea Electrical Substation and Power Distribution System

(71) Applicant: EXXON MOBIL UPSTREAM RESEARCH COMPANY, Houston, TX (US)

(72) Inventor: John Leslie Baker, Houston, TX (US)

(21) Appl. No.: 14/386,676

(22) PCT Filed: Apr. 19, 2013
(86) PCT No.: PCT/US13/37453

§ 371 Date: Sep. 19, 2014

Related U.S. Application Data
(60) Provisional application No. 61/369,501, filed on Jul. 30, 2010.
(60) Provisional application No. 61/780,459, filed on Mar. 13, 2013.

(51) Int. Cl. H02J 11/00; H02B 3/00; H02B 7/01

(52) U.S. Cl. CPC H02J 11/00; H02B 7/01; H02B 3/00
USPC 361/191; 307/40; 29/825

(57) ABSTRACT

A subsea electrical subsystem and a power distribution utilizing the same. The electrical substation located subsea is electrically connected to AC power provided by a power generator located topside. The electrical substation comprises a plurality of circuit breakers and a circuit breaker operating system associated with each circuit breaker. The circuit breaker operating system is constructed and arranged to operate the associated circuit breaker and is operatively connected to at least one control module. The control modules are electrically connected to a DC power supply located topside.

### RELATED APPLICATION

This application claims the priority benefit of U.S. Provisional Patent Application 61/780,459 filed 13 Mar. 2013 entitled METHOD FOR DESIGN OF SUBSEA ELECTRICAL SUBSTATION AND POWER DISTRIBUTION SYSTEM and U.S. Patent Application No. 61/639,501, filed Apr. 27, 2012 entitled METHOD FOR DESIGN OF SUBSEA ELECTRICAL SUBSTATION, the entirety of which is incorporated by reference herein.

### FIELD OF INVENTION

This invention generally relates to the field of electrical substations and, more particularly, to subsea electrical substations powered and controlled from topside facilities.

### BACKGROUND

This section is intended to introduce various aspects of the art, which may be associated with exemplary embodiments of the present invention. This discussion is believed to assist in providing a framework to facilitate a better understanding of particular aspects of the present invention. Accordingly, it should be understood that this section should be read in this light, and not necessarily as admissions of prior art.

Subsea electrical substations are often required for large electrical power consumption subsea hydrocarbon production fields located in deep water. Typically, the subsea electrical substations are many kilometers from a source of electrical power. The maintenance related difficulties presented to subsea electrical substations become more burdensome in Arctic applications. The Arctic conditions often make it nearly impossible to access the subsea electrical substation for maintenance for months at a time due to ice cover. Deep water applications further require expensive recovery vessels to retrieve failed subsea electrical hardware.

There are a variety of known subsea electrical substation electrical protection and control designs and a majority of which are based on two concepts. The first concept can be thought of as basic topside electrical protection and control systems which are installed subsea in a one atmosphere enclosure. This concept relies on standard topside components and redundancy to improve availability. However, the use of systems designed for topside use has its drawbacks which include the high likelihood that the components will fail in the subsea environment. There is then the consequential requirement to retrieve the entire substation module and return it to a remotely located vendor shop for disassembly and repair. As noted above, the ability to retrieve a subsea module is expensive and in some environments, such as the Arctic, may be impossible for 10 months of the year. Current “topside/shore based” designs of this type often require routine maintenance intervention.

The second concept involves retrievable electrical control and protection modules Which are installed subsea. Electrical control power is typically derived from subsea installed control power transformers, battery packs or complex uninterruptible power supplies. This design often requires a ship based remotely operated vehicle (ROV) for control module maintenance and a complete removal of the subsea substation to service failed control power components. Again, there are a variety of disadvantages of being forced to retrieve the entire subsea station in the event repair is needed.

Thus, there is a need for improvement in this field.

### SUMMARY OF THE INVENTION

The present invention provides a system and method for improving subsea substation reliability and availability.

One embodiment of the present disclosure is a A power distribution system comprising: a power generator constructed and arranged to provide AC power, the power generator is located topside; a direct current power supply located topside; a control system located topside; an electrical substation located subsea, the electrical substation is electrically connected to the AC power provided by the power generator, the electrical substation comprises a plurality of circuit breakers and a circuit breaker operating system associated with each circuit breaker, the circuit breaker operating system is constructed and arranged to operate the associated circuit breaker; a bus assembly electrically connected to each circuit breaker; and a plurality of control modules positioned subsea, the control modules are electrically connected to the direct current power supply and communicatively connected to the control system, each control module is operatively connected to a circuit breaker operating system.

The foregoing has broadly outlined the features of one embodiment of the present disclosure in order that the detailed description that follows may be better understood. Additional features and embodiments will also be described herein.

### BRIEF DESCRIPTION OF THE DRAWINGS

The present invention and its advantages will be better understood by referring to the following detailed description and the attached drawings.

FIG. 1 is a block diagram of an electrical system according to one embodiment of the present disclosure.

FIG. 2 is a block diagram of an electrical substation according to one embodiment of the present disclosure.

FIG. 3 is a block diagram of the communicative connection between circuit breaker operating systems and breaker control and protection modules according to one embodiment of the present disclosure.

FIG. 4A is a cross-sectional view of a power and communications umbilical according to one embodiment of the present disclosure.

FIG. 49 is an exploded cross-sectional view of the auxiliary power and communications cable depicted in FIG. 4A.

FIG. 5 is a flowchart showing the basic steps of retrieving a breaker control and protection module according to one embodiment of the present disclosure.

It should be noted that the figures are merely examples of several embodiments of the present invention and no limitations on the scope of the present invention are intended thereby. Further, the figures are generally not drawn to scale, but are drafted for purposes of convenience and clarity in illustrating various aspects of certain embodiments of the invention.

### DETAILED DESCRIPTION

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

Embodiments of the present disclosure provide a modular and reliable electrical substation, or subsea switchgear, designed to operate without intervention for extended periods of time. The substation can be subsea 36 kV class switchgear. The switchgear power devices can consist of standard circuit-breakers, low power type instrument transformers and insulated bus bar assemblies. The switchgear components can be housed in a pressurized enclosure. The enclosure can be, but is not limited to, gas or oil filled. In one embodiment, the enclosure is filled with SF₆ gas.

In order to maximize the overall system availability, the control and protection electronics for each circuit breaker can be housed in separately recoverable modules rather than the enclosure housing the circuit breaker operating mechanism. Such a configuration assists in decreasing the mean time to repair in the event the substation or associated equipment needs to be serviced, thereby leading to enhanced functional availability of the substation.

The control and protection electronics in each module can be constructed and arranged to automatically protect and control an adjacent circuit breaker along with its primary circuit breaker which also enhances the reliability availability of the power supply to the loads. In the event a breaker control and protection module should fail, the redundant configuration of the control and protection module allows any module to be replaced without losing control of the associated circuit breaker. In those embodiments providing such redundant control and protection, the availability of power to the load is maintained even during the short time required to replace the module.

In some embodiments, auxiliary power can be provided to the substation from the shore station (or other source supply). The auxiliary power can be provided by means of redundant direct current cables integrated in an umbilical (i.e., submarine power cable). In some embodiments, the HV DC can be stepped down before being delivered to the control and protection systems. By independently powering the control system, the status of each circuit breaker can be monitored and controlled during a black start without the need for a complex subsea battery supplied uninterruptible auxiliary power system.

Embodiments of the overall system can include a communication system. The communicative link between the switchgear module and the shore station can be made via redundant fiber optic cables also integrated into the umbilical. The communicative link can also be provided in a separate communications line. A remote control and monitoring system allows for a reconfiguration of the electronic devices thus making it possible to adapt the power system operation to current conditions at the subsea site.

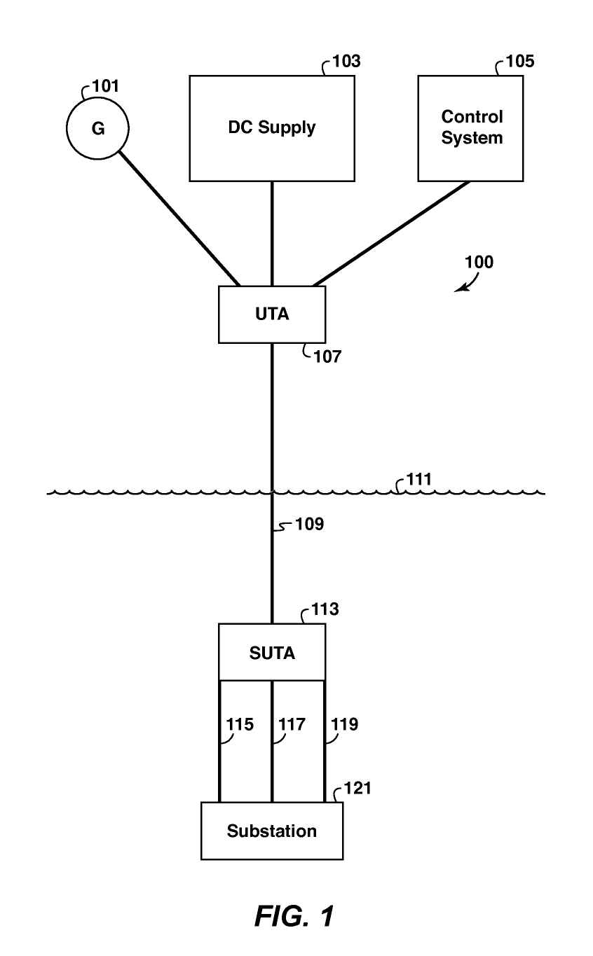

FIG. 1 is a block diagram of a power distribution system 100 according to one embodiment of the present disclosure. As depicted, the power distribution system 100 includes a generator 101 constructed and arranged to generate high voltage AC power, a DC power supply 103 constructed and arranged to provide high voltage DC power, and a control system 105. Though only one generator, DC supply and control system are depicted, other embodiments may include multiple generators, DC supplies and/or control systems. Equipment ancillary to AC power generators and DC power supplies, such as, but not limited to, transformers, circuit breakers, etc., have not been depicted for clarity purposes, though the inclusion and use of such equipment in electrical systems of the current disclosure would be known and appreciated by those skilled in the art. As appreciated by those skilled in the art, the source of the power can be local generation or through a connection with a local utility. The selection of the HV DC voltage can depend on several factors, such as, but not limited to, the total number of substations connected to the same power source, in some embodiments, the HV DC voltage is between 2 kV and 10 kV, though other voltages may be appropriate depending on design objectives and system configuration.

Returning to FIG. 1, the output of generator 101, DC supply 103 and control system 105 are provided to a topside umbilical termination assembly (UTA) 107. As understood by those skilled in the art, the UTA 107 is the interface between the topside equipment and the main umbilical 109. it is the main umbilical 109 which provides HV AC, HV DC and a communications line from the topside, through the waterline 111, and to a subsea substation 121. As used herein, the term “topside” means above the waterline.

As depicted, a subsea UTA 113 is provided to separate the various cables bundled within the umbilical 109. More particularly, a HV AC cable 115, a HV DC cable 117 and a communication cable 119 are provided to the substation 121 and its associated equipment.

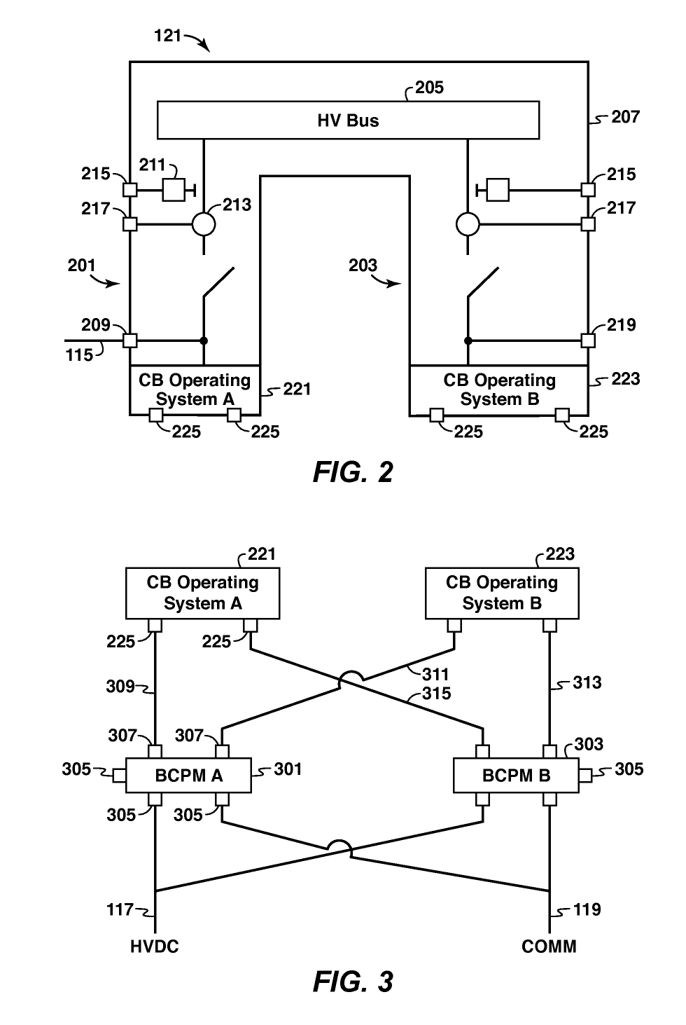

FIG. 2 is a block diagram of an electrical substation 121 according to one embodiment of the present disclosure. As depicted, electrical substation 121 houses two circuit breakers 201, 203. The circuit breakers 201, 203 are electrically connected to bus 205. The electrical substation may include more circuit breakers depending on the design objectives and needs of the overall electrical system. These high voltage components are housed within an enclosure 207. In some embodiments, the HV AC power equipment in the substation is constructed and arranged to operate within a gas or oil-based insulation medium. Enclosure 207 can be filled with SF₆ gas, insulating oil, or other insulating media. The enclosure can have a pressure of 1.5 bar, though other pressures may be applied. Enclosure 207 may be constructed of a variety of materials, such as, but not limited to steel. For example, S355J12, P500QL2 and 80HLES steels can be utilized for the construction of enclosure 207.

In the depicted embodiment, circuit breaker 201 functions as the incoming breaker. As a result, HV AC line 115 is connected at input 209. As appreciated by those skilled in the art, when breaker 201 is in its closed position, HV AC is provided to bus 205 and all circuit breakers connected thereto. In some embodiments, sensor devices are also provided for each circuit breaker in order to provide information to the control and electrical protection system. In the depicted embodiment, a non-contact voltmeter 211 and low power current transformer 213 are associated with each circuit breaker 201, 203. The voltmeters 211 and current transformers 213 are electrically and/or communicatively connected to sensor output terminals 215 and 217, respectively. Load connection 219 enables the HV AC to be delivered to a load in the event circuit breakers 201 and 203 are closed.

Associated with each circuit breaker 201, 203 is a circuit breaker operating system 221, 223, respectively. Each circuit breaker operating system 221, 223 is electrically connected to its associated circuit breaker. In one embodiment, the circuit breaker operating systems have their own enclosure. In one embodiment, the circuit breaker operating systems are enclosed at a relative pressure of 1.5 bar. In one embodiment, the circuit breaker operating systems are filled in an N₂ atmosphere. In some embodiments, there is no pressure differential between the internal pressures of the HV AC enclosure and the circuit breaker operating system enclosure.

Further, each circuit breaker operating system 221, 223 has protection module connections 225. In the depicted embodiment, the circuit breaker operating systems have two protection module connections such that two independent protection modules may be electrically connected to the circuit breaker operating system.

FIG. 3 is a block diagram of the communicative connection between circuit breaker operating systems 221, 223 and breaker control and protection modules 301, 303 according to one embodiment of the present disclosure. As depicted, each breaker control and protection module (BCPM) 301, 303 is housed separately from substation 121. Each BCMP 301, 303 has three input connections 305 and two output terminals 307. With respect to the input connections, each BCPM is connected to the HV DC line 117 and communications line 119. Additionally, each BCPM is connected to output of the voltmeters and current transformers associated with the associated circuit breaker(s) with which the BCPM controls and protects. Though three input connections are depicted, additional inputs may be provided pursuant to design objective and more connections may be provided for each function (such as, but not limited to, multiple connections for the sensor input signal). Connections to the switchgear and associated equipment and modules can be made via wet mate connectors.

As noted above, each BCPM 301, 303 may provide control and protection for multiple circuit breakers. Each BCPM houses the protection relay and power supplies required for correct operation of the associated circuit breaker(s). In order to enhance the switchgear module reliability and availability, each circuit breaker can also be protected and controlled by the BCPM of an adjacent or separate circuit breaker. The redundant configuration provided in FIG. 3 helps to enable a more reliable system. In one embodiment, each BCPM provides “main” control to one CB operating system and “auxiliary” control to another CB monitoring system. In the depicted embodiment, BCPM 301 provides its main control to CB operating system 221 via control line 309. BCPM 301 also provides auxiliary control to CB operating system 223 via control line 311. In turn, BCPM 303 provides its main control to CB operating system 223 via control line 313. BCPM 303 provides auxiliary control to CB operating system 221 via control line 315. The BCPM has the same functionality regardless of its role as “main” or “auxiliary” control.

In one embodiment, the BCPMs are individually retrievable. In the event a BCPM must be retrieved for repair, the overall system can continue uninterrupted. As described herein, the protection, monitoring and control of the substation can be provided by an adjacent BCPM without any modifications to the configuration of the substation or BCPM during the retrieval process. Because the trip and close coils of the CB operating systems have a dedicated power supply, they can be switched on and off remotely from the shore station or topside control system.

Based on information received at a sensor input connection 305, each BCPM can autonomously monitor a variety of conditions, such as, but not limited to, the circuit breaker output current. In the event a parameter exceeds a predefined value, the BCPM trips the breaker off through power or communication provided through a control line. The trip values can be configured from the topside control system or station. As previously described, in order to ensure the seamless transfer of protection in the event of the BCPM failure, each circuit breaker can be effectively protected by two BCPMs. In such a configuration, both BCPMs will race to trip the breaker off via independent trip coils should an over current, or other event, occur.

Through connection to communication line 119, each BCPM 303 can be in constant communication with the topside control system. In some embodiment, the BCPM will continuously, periodically, or upon command report information to the topside control system. The information report can comprise the status of the breaker current, breaker position and health of the BCPM, such as the breaker trip spring charge. From the surface via the BCPM, the breaker can be commanded to open or close and/or the trip spring can be commanded to be charged.

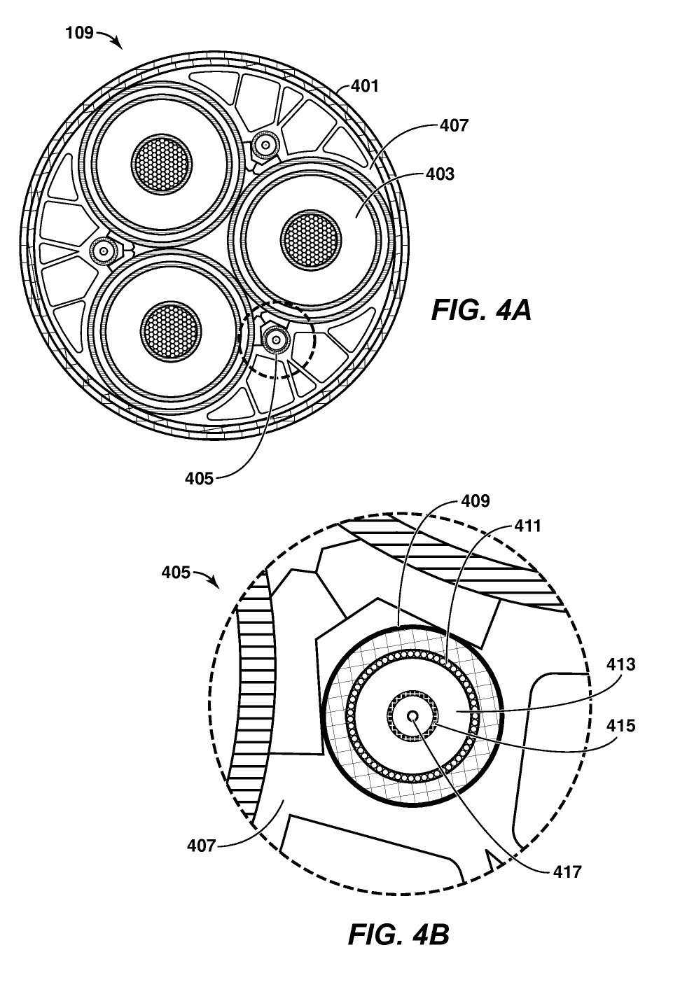

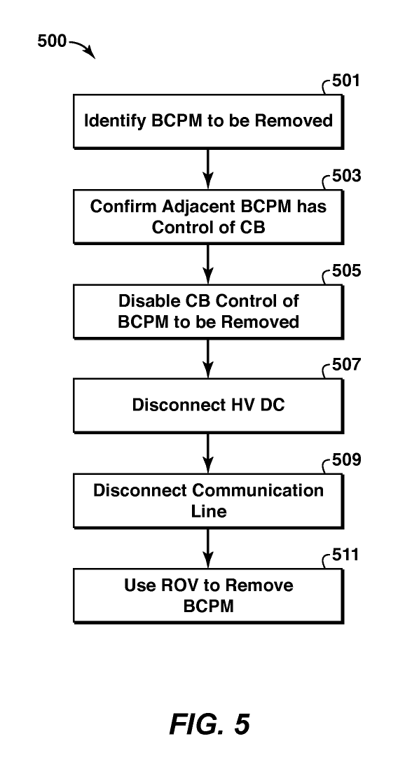

FIG. 4A is a cross-sectional view of a power and communications umbilical 109 according to one embodiment of the present disclosure. As depicted, umbilical 109 is surrounded by a main sheath 401. Main sheath 401 is constructed and arranged to withstand the stresses typically encountered in subsea conditions. In the depicted embodiment, three HV AC lines 403 are provided. In addition, three auxiliary power and communication cables 405 are provided. Though three auxiliary power and communication cables 405 are depicted, other embodiments can have fewer or more. Support structures 407 can also be provided to support the overall rigidity of umbilical 109 and/or maintain the placement of auxiliary power and communication cables 405.

FIG. 4B is an exploded cross-sectional view of the auxiliary power and communications cable 405 depicted in FIG. 4A. Auxiliary power and communication cables 405 include a sheath 409, an outer coaxial conductor 411, insulator 413, inner coaxial conductor 415 and a fiber optic line 417. The auxiliary power and communication cables 405 are provided in order to provide communications and DC power to the BCPMs. For each auxiliary power and communications cable 405, a coaxial configuration is shown to reduce coupling with the main AC conductors 403, in order to supply several kilowatts of power to one or more BCPM located a distance (such as, but not limited to, up to 150 km) from the topside supply, the outer coax conductor 411 and inner coax conductor 415 can be sized such that the electrical resistance is not more than 1 Ω/km. in one embodiment, the conductors are constructed and arranged to operate at 10 kV DC. In one embodiment, a plurality of optical fibers comprise fiber optic line 417.

FIG. 5 is a flowchart showing the basic steps of retrieving a breaker control and protection module according to one embodiment of the present disclosure. Process 500 begins by identifying the BCPM that must be removed (block 501). The BCPM can be identified via communication to the topside control system. The BCPM may be removed due to identification of a malfunction, periodical repair, etc. The identification can be based on information received from monitoring devices related to each circuit breaker within the substation. The monitoring devices can be, but are not limited to, voltmeters and/or current transformers.

Before the BCPM is removed, the control system confirms that the adjacent BCPM has control of the circuit breaker which is primarily controlled by the BCPM to be removed (block 503). Once confirmation has been received, CB control of the BCPM is disabled (block 505). Next, the DC supply to the BCPM is disconnected (block 507). The communication and sensor lines are also disconnected (block 509). Upon successful disconnection of the necessary lines, a remote operated vehicle (ROV) or other appropriate device can be used to remove the BCPM (block 511).

While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional blocks not shown herein. While the figures illustrate various actions occurring serially, it is to be appreciated that various actions could occur in series, substantially in parallel, and/or at substantially different points in time.

Disclosed aspects may be used in hydrocarbon management activities. As used herein, “hydrocarbon management” or “managing hydrocarbons”” includes hydrocarbon extraction, hydrocarbon production, hydrocarbon exploration, identifying potential hydrocarbon resources, identifying well locations, determining well injection and/or extraction rates, identifying reservoir connectivity, acquiring, disposing of and/or abandoning hydrocarbon resources, reviewing prior hydrocarbon management decisions, and any other hydrocarbon-related acts or activities. The term “hydrocarbon management” is also used for the injection or storage of hydrocarbons or C0₂, for example the sequestration of C0₂, such as reservoir evaluation, development planning, and reservoir management. In one embodiment, the disclosed methodologies and techniques may be used to extract hydrocarbons from a subsurface region. In such an embodiment, embodiments described herein can be used to power equipment associated with hydrocarbon production or extraction. The equipment and techniques used to drill a well and/or extract the hydrocarbons are well known by those skilled in the relevant art. Other hydrocarbon extraction activities and, more generally, other hydrocarbon management activities, may be performed according to known principles.

The following lettered paragraphs represent non-exclusive ways of describing embodiments of the present disclosure.

A. A power distribution system comprising: a power generator constructed and arranged to provide AC power, the power generator is located topside; a direct current power supply located topside; a control system located topside; an electrical substation located subsea, the electrical substation is electrically connected to the AC power provided by the power generator, the electrical substation comprises a plurality of circuit breakers and a circuit breaker operating system associated with each circuit breaker, the circuit breaker operating system is constructed and arranged to operate the associated circuit breaker; a bus assembly electrically connected to each circuit breaker; and a plurality of control modules positioned subsea, the control modules are electrically connected to the direct current power supply and communicatively connected to the control system, each control module is operatively connected to a circuit breaker operating system.

A1. The power distribution system of paragraph A, wherein the electrical substation further comprises at least one monitoring device associated with each circuit breaker, the monitoring device is constructed and arranged to detect the status conditions of the associated circuit breaker.

A2. The power distribution system of paragraph A1, wherein the status conditions may be selected from a group consisting of circuit breaker current, circuit breaker position and health of the protection module.

A3. The power distribution system recited in any of paragraphs A to A2, wherein the circuit breakers and the bus assembly are housed in a substation enclosure.

A4. The power distribution system of paragraph A3, wherein the substation enclosure is filled with SF₆ gas.

A5. The power distribution system recited in any of paragraphs A to A4, wherein the control modules are housed in a module enclosure.

A6. The power distribution system of paragraph A5, wherein the module enclosure is filled with N₂.

A7. The power distribution system recited in any of paragraphs A to A6, wherein each circuit breaker operating system electrically connected to more than one control module.

A8. The power distribution system recited in any of paragraphs A to A7, wherein the control system is communicatively connected to the control module by a fiber optic cable.

B. A method of servicing a power distribution system comprising: providing the power distribution system comprising: a power generator constructed and arranged to provide AC power, the power generator is located topside; a direct current power supply located topside; a control system located topside; an electrical substation located subsea, the electrical substation is electrically connected to the AC power provided by the power generator, the electrical substation comprises a plurality of circuit breakers and a circuit breaker operating system associated with each circuit breaker, the circuit breaker operating system is constructed and arranged to operate the associated circuit breaker; a bus assembly electrically connected to each circuit breaker; and a plurality of control modules positioned subsea, the control modules are electrically connected to the direct current power supply and communicatively connected to the control system; identifying a first control module to be removed, the first control having control over a first circuit breaker operating system; disconnecting the first control module from the direct current power supply and control system; and removing the first control module from its subsea location.

B1. The method of paragraph B further comprising receiving confirmation that a second control has control of the first circuit breaker operating system.

B2. The method of paragraph B or B1, wherein the first control module is removed by a remote operated vehicle.

B3. The method recited in any of paragraphs B to B2, wherein the electrical substation further comprises at least one monitoring device associated with each circuit breaker, the monitoring device is constructed and arranged to detect the status conditions of the associated circuit breaker.

B4. The method recited in any of paragraphs B to B3, wherein the identification of the first control module to be removed is based upon the detected status conditions of the associated circuit breaker.

B5. The method recited in any of paragraphs B to B4, wherein the electrical connection of the substation to the AC power is maintained while the first control module is removed from its subsea location.

It should be understood that the preceding is merely a detailed description of specific embodiments of this invention and that numerous changes, modifications, and alternatives to the disclosed embodiments can be made in accordance with the disclosure here without departing from the scope of the invention. The preceding description, therefore, is not meant to limit the scope of the invention. Rather, the scope of the invention is to be determined only by the appended claims and their equivalents. It is also contemplated that structures and features embodied in the present examples can be altered, rearranged, substituted, deleted, duplicated, combined, or added to each other. The articles “the”, “a” and “an” are not necessarily limited to mean only one, but rather are inclusive and open ended so as to include, optionally, multiple such elements.

What is claimed is:

1. A power distribution system comprising:
a power generator constructed and arranged to provide AC power, the power generator is located topside;
a direct current power supply located topside;
a control system located topside;
an electrical substation located subsea, the electrical substation is electrically connected to the AC power provided by the power generator, the electrical substation comprises a plurality of circuit breakers and a circuit breaker operating system associated with each circuit breaker, the circuit breaker operating system is constructed and arranged to operate the associated circuit breaker;
a bus assembly electrically connected to each circuit breaker; and
a plurality of control modules positioned subsea, the control modules are electrically connected to the direct current power supply and communicatively connected to the control system, each control module is operatively connected to a circuit breaker operating system.

2. The power distribution system of claim 1, wherein the electrical substation further comprises at least one monitoring device associated with each circuit breaker, the monitoring device is constructed and arranged to detect the status conditions of the associated circuit breaker.

3. The power distribution system of claim 2, wherein the status conditions may be selected from a group consisting of circuit breaker current, circuit breaker position and health of the protection module.

4. The power distribution system of claim 1, wherein the circuit breakers and the bus assembly are housed in a substation enclosure.

5. The power distribution system of claim 4, wherein the substation enclosure is filled with SF₆ gas.

6. The power distribution system of claim 1, wherein the control modules are housed in a module enclosure.

7. The power distribution system of claim 6, wherein the module enclosure is filled with N₂.

8. The power distribution system of claim 1, wherein each circuit breaker operating system electrically connected to more than one control module.

9. The power distribution system of claim 1, wherein the control system is communicatively connected to the control module by a fiber optic cable.

10. A method of servicing a power distribution system comprising:
providing the power distribution system comprising:
a power generator constructed and arranged to provide AC power, the power generator is located topside;
a direct current power supply located topside;
a control system located topside;
an electrical substation located subsea, the electrical substation is electrically connected to the AC power provided by the power generator, the electrical substation comprises a plurality of circuit breakers and a circuit breaker operating system associated with each circuit breaker, the circuit breaker operating system is constructed and arranged to operate the associated circuit breaker;
a bus assembly electrically connected to each circuit breaker; and
a plurality of control modules positioned subsea, the control modules are electrically connected to the direct current power supply and communicatively connected to the control system;
identifying a first control module to be removed, the first control having control over a first circuit breaker operating system;
disconnecting the first control module from the direct current power supply and control system; and
removing the first control module from its subsea location.

11. The method of claim 10 further comprising receiving confirmation that a second control has control of the first circuit breaker operating system.

12. The method of claim 10, wherein the first control module is removed by a remote operated vehicle.

13. The method of claim 10, wherein the electrical substation further comprises at least one monitoring device associated with each circuit breaker, the monitoring device is constructed and arranged to detect the status conditions of the associated circuit breaker.

14. The method of claim 13, wherein the identification of the first control module to be removed is based upon the detected status conditions of the associated circuit breaker.

15. The method of claim 10, wherein the electrical connection of the substation to the AC power is maintained while the first control module is removed from its subsea location.
